(19) United States
(12) Patent Application Publication
(10) Pub. No.: US 2014/0062876 A1
(43) Pub. Date: Mar. 6, 2014

(54) EYE-CONTROLLED COMMUNICATION SYSTEM

(71) Applicant: UTECHZONE CO., LTD., New Taipei City (TW)

(72) Inventors: CHIA-CHUN TSOU, NEW TAIPEI CITY (TW); CHIH-HENG FANG, NEW TAIPEI CITY (TW); PO-TSUNG LIN, NEW TAIPEI CITY (TW)

(73) Assignee: UTECHZONE CO., LTD., NEW TAIPEI CITY (TW)

(21) Appl. No.: 13/672,243

(22) Filed: Nov. 8, 2012

(30) Foreign Application Priority Data
Aug. 29, 2012 (TW) 101131425

(51) Int. Cl. G06F 3/01

(52) U.S. Cl. CPC G06F 3/013
USPC 345/158

(57) ABSTRACT

An eye-controlled communication system comprises an eye controlled aid and a visiting aid. The eye controlled aid has an eye controlled module, a first display module and a first processing unit. The eye controlled module detects eye movements of patient, generates a control command based on the detected results and then transmits to the first processing unit. The first processing unit bases the control command to allow patient to operate the first operator interface by using eye movements. The first processing unit generate an execute command according to the operating results, and performs the execute command, wherein the execute command includes information of transmitting messages to the second processing unit. The second processing unit receives the execute command and performs the execute command. Thus, the system of the present invention can help patient to easily express himself or herself to his or her family members or friends.

### BACKGROUND OF INVENTION

1. Field of Invention

The invention relates to a communication system by using eye movements, and more especially to an eye-controlled communication system that is especially applicable to an isolation ward in a medical care place.

2. Related Prior Art

A great deal of technology that detects eye movements for control purpose has been developed and well known in public. For instance, U.S. Pat. No. 6,003,991 (hereinafter called '991) suitable for medical field is entitled as “Eye examination apparatus and method for remote examination of a patient by a health professional”, which relates to glasses for a patient to wear. A camera is disposed in front of the glasses for capturing images of patient's eyes. The images of the patient's eyes are then sent to a computer device and a display by transmission lines. As such, a doctor can clearly examine patient's eyes, thereby performing treatment or medical research.

Numerous research teams, such as TempOne, Graffiti Research Lab, OpenFrameworks, The Ebeling Group and etc., developed an eye control device, named as “The EyeWriter”, in 2007. The EyeWriter is a project developed by a group of software program developing experts who aim to help a street performer, Samuel Taylor Coleridge suffering from ALS (Amyotrophic lateral sclerosis) that makes him progressive immobility, allowing him to create art using only his eyes. The EyeWriter is to detect eye movements by using two cameras attached to the frames of the glasses and facing user's eyes, and by using software to read data, which allows Samuel to paint again only using his eyes instead of his hands.

In addition, MyTobii P10 is an auxiliary device for helping patients, which has developed by Tobii Company, a Sweden company. The basic principle of this device is to detect eye movements to perform control function, which is similar to the previously mentioned device. The difference between The EyeWriter and MyTobii is that MyTobii includes a LCD screen and an eye movement detector located below the LCD screen. The eye movement detector of MyTobii detects the eye movements of a patient, thereby controlling a mouse cursor on the LCD screen simultaneously. Thus, patients can operate functions on the LCD screen by using their eyes. Besides, products, such as Tobii C15, Tobii C8, Tobii C12 and etc. also have similar functions.

As disclosed by the above-mentioned technology, such as '991, The EyeWriter, and MyTobii, they are similar solutions based on different motivations, which could be operated reasonably and has certain effects. However, the device disclosed by '991 and The EyeWriter is not very convenient for those patients who have already worn a pair of glasses or who are lying on a bed because this kind of device includes a camera attached to glasses and located in front of the glasses or below the glasses for capturing images of eyes. In one aspect, in order to well support the cameras that are additionally attached onto the frames of the glasses, it is necessary to redesign the frames of the glasses to meet the needs. This would thus limit the shape of the glasses, which gives users less choices for glasses. In another aspect, patients who are not able to move freely and have to lie on the bed due to surgery or other reasons, need nurses' help to turn over. When patients is turned aside to perform any kinds of medical treatment, like changing medicine, the frames of the glasses would be moved away from the original position where captures the images of eyes. Moreover, when the patient is turned to the left side or the right side, the frame of glasses would press patients' ears. Accordingly, the aforementioned situations would cause various troubles in practical use.

### SUMMARY OF INVENTION

The products made by Tobii Company still exist few problems which need to be solved although there is no problem when using the glasses. One of the most common situations is that when patient stays in an isolation ward, patient's family members or friends can see the patient only through a tablet computer or monitor. This causes that patient neither sees his or her family members or friends, nor communicates with them. Patient's family members or friends cannot communicate with him or her either.

Another one of the most common situations is that the only way to communicate with patient is to go to the place where patient stays. It is not very convenient for patient's family members or friends, and it would spend lots of time in transportation and cost a lot, which results in low willingness to visit patient for patient's family members or friends.

There is one more common situation. When patient feels uncomfortable and would like to inform the medical care personnel, the medical care personnel have to watch the screen at the patient's side to know what the patient wants, and therefore provide medical treatment. However, in practical use, the screen faces the patient, and thus there are only two ways to know what information the patient sent. First, the medical care personnel have to move near the patient and view the screen at the same viewing angle as the patient does. Second, the medical care personnel can adjust the patient's screen. Nevertheless, in fact, it causes some problems no matter which way are used.

Accordingly, the present invention provides an eye-controlled communication system, which comprises an eye controlled aid and a visiting aid. The former one is located inside of an isolation ward for a patient to operate it. The later one is located outside of the isolation ward for patient's family members or friends to use it. The eye controlled aid includes a first display module, a first processing unit and an eye controlled module. The eye controlled module detects eye movements of the first user, generates a control command according to the detected eye movements, and transmits the control command to the first processing unit. The first processing unit is configured with a first operator interface, and the first processing unit bases on the control command transmitted from the eye controlled module to allow the first user to the first operator interface by using eye movements. The first processing unit generate an execute command according to the operating results, and performs the execute command. The execute command includes information of transmitting messages to the second processing unit. The second processing unit receives the execute command transmitted from the first processing unit and performs the execute command. For example, the second processing unit drives the display module to display the messages of the execute command on the screen of the display module. Thus, the eye controlled aid and the visiting aid can help patient to express himself or herself to his or her family members or friends who stay outside of the isolation ward by using eye movements.

Preferably, the second processing unit is configured with a second operator interface displayed on the second screen of the second display module, and the second processing unit transmits the information, such as text message, from their family members or friends by using the second operator interface to the first processing unit. The first processing unit receives the information from the second processing unit and drives the first screen of the first display module to display the information thereon. Therefore, the patient's family members or friends stay outside of the isolation ward can well express themselves to the patient stays inside of the isolation ward by using the second processing unit and the second operator interface.

Preferably, the eye controlled aid further includes a third display module for the medical care personnel to use. The third display module is electrically connected with the first processing unit. The first process unit generates a third operator interface displayed on the third screen of the third display module, and the first processing unit drives the first screen of the first display module to display the information from the medical care personnel on the first screen. Therefore, the medical care personnel can communicate with the patient by using the first processing unit and the third display module.

Preferably, in one embodiment of the eye-controlled communication system of the present invention, the first processing unit is capable of driving the third display module to display the information from the patient by operating the first operator interface by eye movements. More, the first processing unit transmits the information to the visiting aid to drive the second display module to display the information thereon simultaneously. As such, the medical care personnel and patient's family member or friends can simultaneously understand what patient expresses through the first processing unit.

Preferably, the system of the present invention includes two display modules electrically connected with each other by a processing unit. This system excludes the above mentioned visiting aid according to the demands. In the embodiment, the two display modules are respectively pivoted on a main post which allows the two display modules to be adjusted to various positions and angles. One of the two display modules is configured with an eye controlled module for a patient and the other is for the medical care personnel.

Compared with the conventional technology, the present invention relates to an eye-controlled communication system, which is more convenient for the patient in the isolation ward and their family members or friends who are away from the isolation ward to communicate with each other. Thus, the present invention solves the problems that family members or friends cannot communicate with the patient who stays in the isolation ward. Moreover, the present invention achieves the functions of communication between the patient and the patient's family member or friends, who stay at home or stay far away from the isolation ward, by wireless communication or network communication. Hence, the present invention solves the problems of inconvenience existing in the conventional technology. In addition, the system of the present invention also includes additional display module for medical care personnel to use, such that the patient and the medical care personnel can well communicate with each other conveniently.

Other features, objects, aspects and advantages will be identified and described in detail below.

### BRIEF DESCRIPTION OF DRAWINGS

FIG. 1 is a blocking diagram illustrating an eye-controlled communication system in accordance with an embodiment of the present invention;

FIG. 2 is a perspective view illustrating the system in accordance with an embodiment of the present invention;

FIG. 3 is a perspective view illustrating the first operator interface of the eye controlled aid in accordance with an embodiment of the present invention;

FIG. 4 is a perspective view illustrating the system applicable to an isolation ward in accordance with an embodiment of the present invention;

FIG. 5 is an enlarged perspective view illustrating the first display module and the first movable frame of the eye controlled aid in accordance with an embodiment of the present invention; and

FIG. 6 is an enlarged perspective view illustrating the second display module and the second movable frame of the eye controlled aid in accordance with an embodiment of the present invention.

### DETAILED DESCRIPTION OF EMBODIMENTS

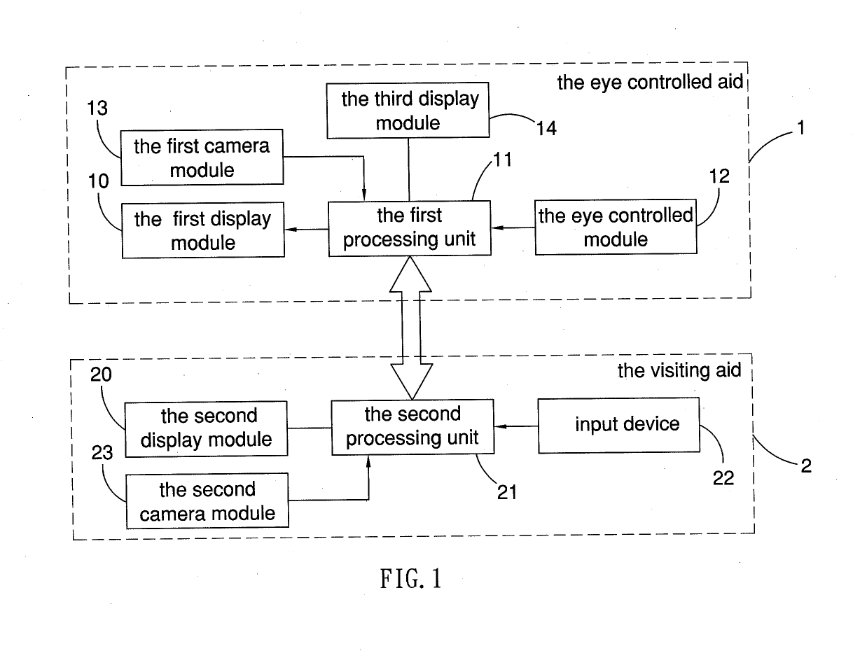

With reference of FIG. 1, an eye-controlled communication system is shown in accordance with an embodiment of the present invention. The system comprises an eye controlled aid 1 for a first user to operate and a visiting aid 2 for a second user to operate. The first user may be a patient and the second user may be a patient's family member or friend. The patient is a person who suffers from Amyotrophic lateral sclerosis (ALS)/Motor neuron disease (MND), Muscular dystrophy (MD), Cerebral palsy (CP), Spinocerebellar Atrophy (SCA), Parkinson's disease (PD) and etc. The eye controlled aid 1 is mainly suitable for those patients mentioned above, but it is also suitable for individuals who have limited or no use of hands or even for health individuals.

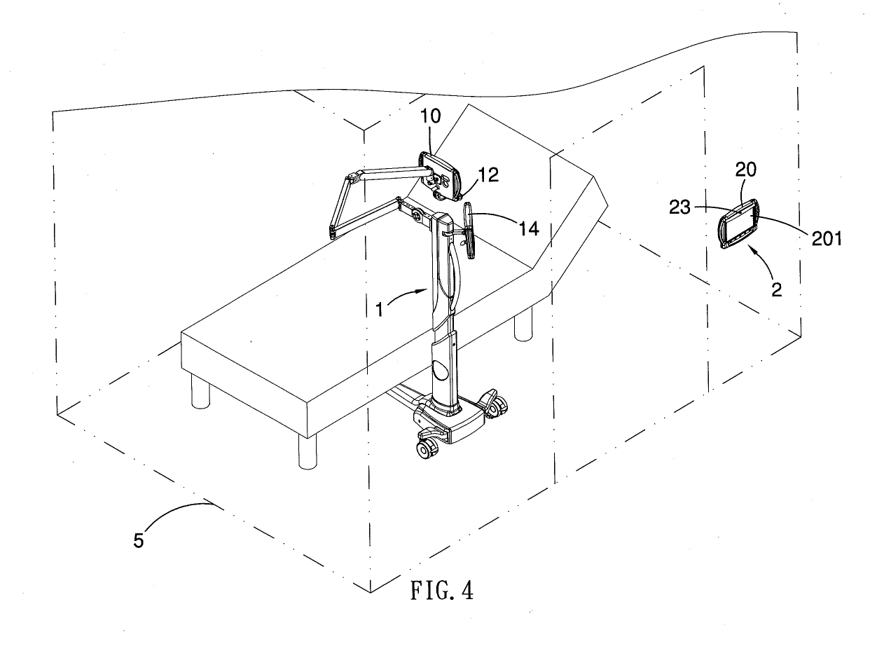

Preferably, as shown in FIG. 4, the eye controlled aid 1 is located inside of an isolation ward 5, and the visiting aid 2 is located outside of the isolation ward 5. The eye controlled aid 1 is electrically connected with the visiting aid 2 by the wireless communication or wired communication to transmit information or data to each other. Examples include network internet access, or wireless communication, such as blue tooth or Wi-Fi.

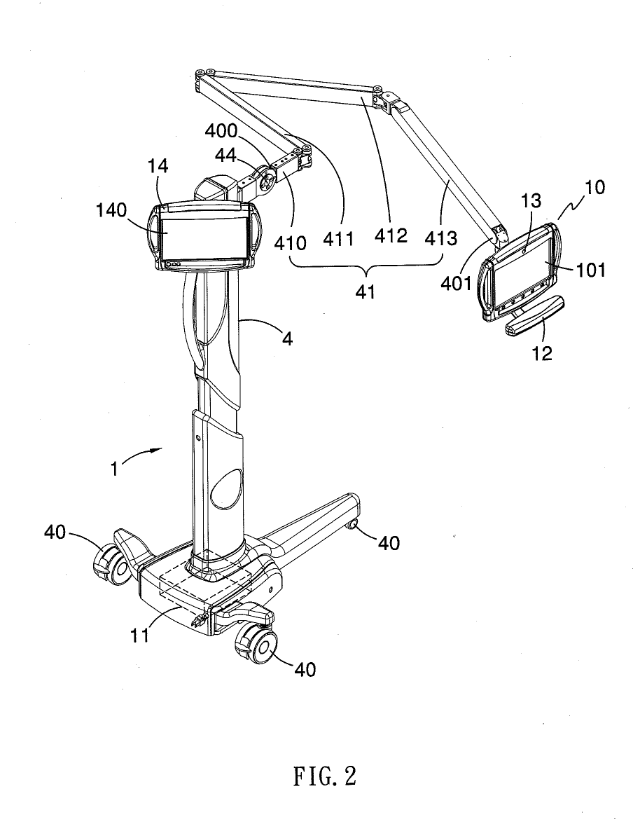

As shown in FIGS. 1 and 2, the eye controlled aid 1 comprises a first display module 10, a first processing unit 11 and an eye controlled module 12. The first display module 10 is electrically connected with a first processing module 11. The first display module 10 has a first screen 101. The first screen 101 is preferably a LCD screen. The eye controlled module 12 is located on the first display module 10 and below the first screen 101. The first processing unit 11 is preferably configured with a computer motherboard installing several applications, such as operating systems, Web browsers, email applications, multimedia applications and so on. The above mentioned applications further include a first application program. The processing unit 11 is electrically connected with the eye controlled module 12 and performs the first application program to generate a first operator interface that is displayed on a first screen 101 of the first display module 10.

As shown in FIGS. 1 and 4, the visiting aid 2 comprises a second display module 20 and a second processing unit 21. The second display module 20 is electrically connected with the second processing unit 21 and having a second screen 201. The second processing unit 21 is preferably a computer motherboard that installs operative systems, output and input drivers (including drivers for the eye controlled module 12), applications (such as Web browsers, email applications, multimedia applications and so on). The second screen 201 of the second display module 20 is preferably a LCD screen or a touch LCD screen. The visiting aid 2 preferably further comprises input devices 22, such as a mouse and/or a keyboard. For instance, if the second screen 201 of the second display module 20 is a touch LCD screen, there is no necessary to use a input device 22. Briefly, the visiting aid 2 is substantially a personal computer, a notebook computer, a tablet computer or a smart phone.

The eye controlled module 12 detects and recognizes the eye movements of the first user (patient), such as eyeball tracking, blinking detection, gaze detection and so on. The eye controlled module 12 generates a control command based on the detected results and transmit the control command to the first processing unit 11. Specifically speaking, eyeball movement in any direction will cause the mouse cursor to move in that direction. For example, the control command may have information of up/down and left/right eye movements, which are respectively associated with moving direction of the mouse cursor. Further, the control command may further have information of clicking function. For example, one blink or long blinks for a predetermined time may trigger the mouse to click. Besides, the control command may further have information of rolling scroll bar, turning to the next page and etc., which may be associated with different eye movements. In short, the eye controlled module 12 generates a corresponding control command according to the detected eye movements and transmits this control command to the first processing unit 11. The first processing unit 11 receives the control command and performs the corresponding action according to the control command.

More specifically speaking, the first processing unit 11 bases on the control command transmitted from the eye controlled module 12 to allow the first user to operate the first operator interface of the first display module 10 by using eye movements, such that the first processing unit 11 generates an execute command corresponding to the operation. The execute command may include transmitting information to the second processing unit 21 of the visiting aid 2. The above mentioned information may be a message, a file, an email, or a programming command. The second processing unit 21 receives the execute command transmitted from the first processing unit 11 and perform the execute command, such as displaying the message, the file or email on the second screen 201 of the second display module 20 for the second user's convenience, or performing the programming command to implement the corresponding action.

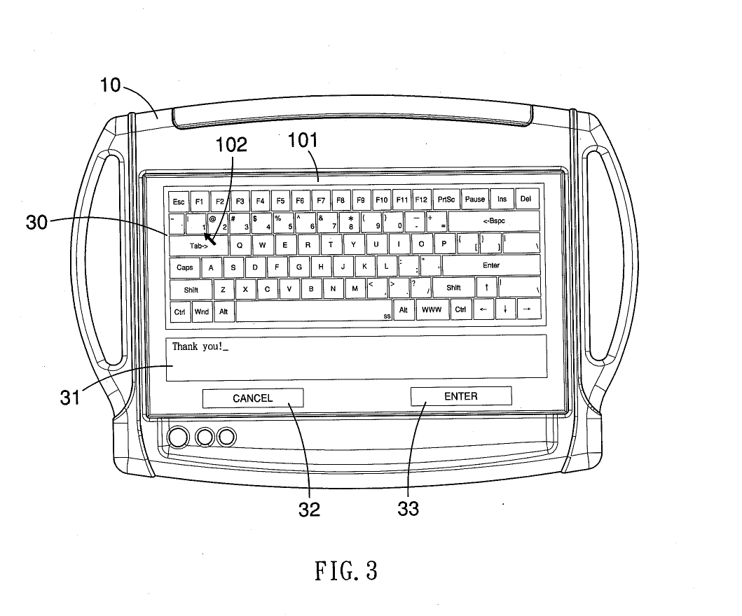

The first operator interface can be designed as, but not limited to, “.net Windows Form” or “.net Web Form”. The first operator interface with user-friendly functions for the first user's convenience should be designed because the first user is a person who can only express himself or herself by using eye movements. FIG. 3 is a drawing showing the first operator interface displayed on the first screen 101 of the first display module 10 in accordance with an embodiment of the present invention. The first operator interface has a keyboard 30, a message entering area 31, a CANCEL key 32, and a ENTER key 33. In this embodiment, when the eye controlled aid 12 allows the first user to user their eyes to move the mouse cursor 102, to click the keys of the keyboard 30, and to click the ENTER key 33, the first processing unit 11 thus performs the following commands based on the previously operation: forming a message, such as “Thank you!”, in the message entering area 31 by clicking the keys of the keyboard 30; generating an information including the above mentioned message; and transmitting the information including the above mentioned message to the second processing unit 21.

When the second processing unit 21 receives the information transmitted from the first processing unit 11, the second processing unit 21 drives the second screen 201 of the second display module 20 to display the message of the information (i.e. the above mentioned ““Thank you!””).

Another example of the first operator interface is illustrated as below. The first operator interface may be preferably capable of providing several of predefined keys. Some of the predetermined keys respectively represent each part of the body, such as head, chest, back, left/right hand, left/right foot and etc., and the other predetermined keys respectively represent different common sensation, such as pain, itch, sting, numbness, sore and etc. Therefore, when the first user gets head pain, for example, the first user can click “head” key from body selection and click “pain” key from common sensation selection. After finishing clicking the information, such as a text message “head pain”, the first processing unit 11 then transmits the information to the second processing unit 21. The information includes the text message, i.e. “head pain”. After the second processing unit 21 receives the information transmitted from the first processing unit 11, the second processing unit 21 drives the second screen of the second display module 20 to display the text message of the information (i.e. “head pain”) on the second screen of the second display module 20.

As illustrated in the previously paragraphs, the eye controlled aid 1 detects the eye movements of the first user (patient) to have the message from the first user and transmit the message to the visiting aid 2. Thus, the second user (i.e. the patient's family member or friends) can immediately know how the first user feels by the visiting aid 2. As such, there is no need for the second user to turn the first screen 101 of the first display module 10 of the eye controlled aid 1 to their side, or to move near the patient and view the first screen 101 of the first display module 10 at the same viewing angle as the first user does. Therefore, the present invention provides an eye-controlled communication system which is more convenient than conventional products (such as products from Tobii Company).

The first processing unit 11 of the eye controlled aid 1 of the system of the present invention is electrically connected with the second processing unit 21 of the visiting aid 2 by wireless communication or network communication. Thus, as shown in FIG. 4, the eye controlled aid 1 can be located inside of the isolation ward 5 for the first user (patient) to operate, and the visiting aid 2 can be located outside of the isolation ward 5 (such as on the door) for the second user (patient's family members or friends) to operate. Therefore, although the patient is isolated, the patient still can communicate with his or her family members or friends via the system of the present invention. In addition, the visiting aid 2 can be also deposited in a house or a place far away from the isolation ward, which can also achieve the functions of communication between the patient and the patient's family member or friends by wireless communication or network communication. Hence, the present invention solves the problems of inconvenience existing in the conventional technology, and therefore achieves purposes of increasing numbers of visiting times.

With reference to the FIGS. 1, 2 and 4, the second processing unit 21 of the visiting aid 2 can preferably have a second operator interface displayed on the second screen 201 of the second display module 20 (because the second processing unit 21 is configured with a second application program therein for providing the second operator interface). The second processing unit 21 transmits the information entered from the second user by using the second operator interface to the first processing unit 11 of the eye controlled aid 1. When the first processing unit 11 receives the information transmitted from the second processing unit 21, the first processing unit 11 drives the first screen 101 of the first display module 10 to display the information on the first screen 101 of the first display module 10. As such, the first user (patient) can get the information from the second user (family member or friends), such as a text message “You look great” or other words, on the first screen 101.

Preferably, the eye controlled aid 1 further includes a first camera module 13 that is disposed above the first display module 10 and electrically connected with the first processing unit 11. The visiting aid 2 further includes a second camera module 23 that is disposed above the second display module 23 and electrically connected with the second processing unit 21. The first processing unit 11 is capable of instantly transmitting an image captured by the first camera module 13 to the second processing unit 21. The second processing unit 21 is capable of instantly transmitting an image captured by the second camera module 23 to the first processing unit 11. The first processing unit 11 is capable of driving the first display module 10 to display the image transmitted from the second processing unit 21. The second processing unit 21 is capable of driving the second display module 20 to display the image transmitted from the first processing unit 11. As such, the first user and the second user can see each other through the first and the second camera module 13 and 23, which would highly enhance the quality of the communication.

With reference FIGS. 1 and 2 again, the eye controlled aid 1 preferably includes a third display module 14 for a third user to use. The third user may be medical care personnel. The third display module 14 is electrically connected with the first processing unit 11. The third display module 14 has a third screen 140, preferably a LCD screen or a touch LCD screen. In one embodiment, the first processing unit 11 allows the first user to operate the first operator interface of the first display module 10 by using eye movements according to the control command transmitted from the eye controlled module 12. After that, the first processing unit 11 generates an execute command corresponding to the operation. The execute command can include information of displaying a message on the third display 14 and transmitting the message to the second processing unit 21. The second processing unit 21 receives the message and then displays the message on the second display module 20. Thus, the second user (family member or friends) and the third user (medical care personnel) can get information from the first user (patient) respectively by the second display module 20 and the third display module 14.

Preferably, the first processing unit 11 further includes a third operator interface that is displayed on the third screen 140 of the third display module 14 (due to the first application program having functions of providing the third operator interface). The first process unit 11 receives a message from the third user by using the operator interface, and drives the first screen 101 of the first display module 10 to display the message on the first screen 101 of the first display module 10. As such, the first user (patient) can see the message, such as “how does you feel” or other words related to the medical conditions, from the third user (medical care personnel).

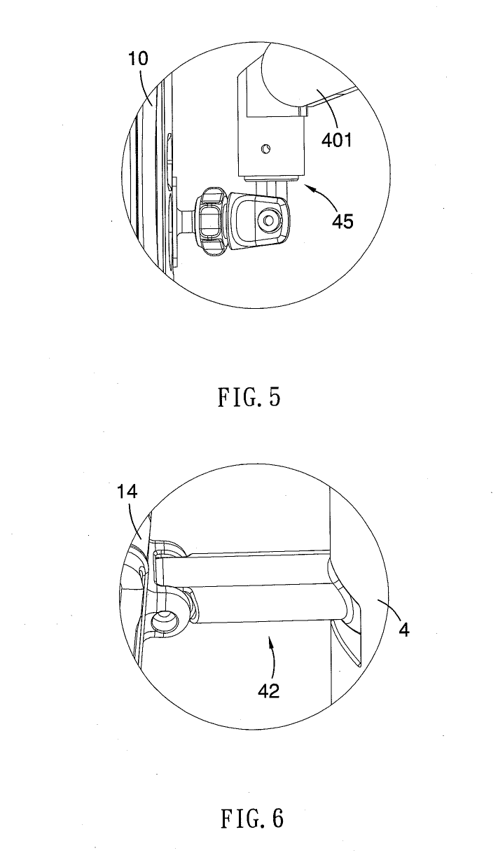

With reference FIG. 2, the eye controlled aid 1 further comprises a main post 4 and a plurality of wheels 40 assembled on a bottom side of the main post 4. The first processing unit 11 is located in the bottom part of the main post 4. The first display module 10 and the third display module 14 are respectively connected with the two sides of the top part of the main post 4. Preferably, the eye controlled aid 1 further comprises a first movable frame 41. The first movable frame 41 has a front end 400 and a rear end 401, which are respectively connected with the top part of the main post 4 and the first display module 10. The first display module 10 is movable and the position of the first display module 10 is adjustable because of the first movable frame 41. The first movable frame 41 preferably includes several cantilevers 410-413. Each of the cantilevers rotatably connected with each other so that the cantilevers are capable of rotating relative to each other. When the first display module 10 is forced to adjust the position of the first display module 10, these cantilevers 410-413 are then be moved. More preferably, the first movable frame 41 is pivoted on the top part of the main post 4 by a rotating shaft 44. As shown in FIG. 5, the rear end 401 of the first movable frame 41 is pivoted on the first display module 10 by a universal connector 45, which allows the first display module 10 to rotate in several axis directions for the first user's convenience to use.

As shown in FIG. 6, the eye controlled aid 1 further includes a second movable frame 42. The second movable frame 42 has two ends respectively pivoted on the top part of the main post and the third display module 14, which allows the third user to adjust the positions of the third display module 14 and the main post 4. Besides, the connecting wires to connect the first processing unit 11 and the first display module 10, the third display module 14 and the eye controlled module are embedded inside of the main post 4, the first movable frame 41 and the second movable frame 42.

Preferably, in one embodiment of the present invention, the communication system can only comprises a main post, a processing unit, an eye controlled module, and two display modules. This means that the above-mentioned visiting aid 2 can be excluded according to the demands. The main post and the processing unit are respectively similar to (or nearly identical to) the main post 41 and the first processing unit 11 as mentioned in the previously embodiments. The eye controlled module and the two display module are respectively similar to (or nearly identical to) the eye controlled module 12, the first display module 10 and the third display module 14, and the eye controlled module and the two display module are electrically connected with the processing unit, respectively. The two display modules are respectively for two different users to operate (one is a patient; the other is a medical care personnel). The two display modules are movably pivoted on the main post, which allows users to adjust the positions and angles of the two display modules. The detailed connecting mechanisms can be referred to the movable frames and the related devices mentioned in the previously embodiments. The eye controlled module generates a control command based on the detected eye movements according to one of the display modules and transmits the control command to the processing unit. The processing unit generated an operator interface that is displayed on a screen of one of the display modules. The processing unit drives one of the display modules to display the operator interface which allows the user (patient) to operate it by using the eye movements according to the control command transmitted from the eye controlled module. The processing unit therefore generates an execute command based on the operating results and performs the execute command. The above-mentioned execute command includes information of generating a message, such as a text message, and displaying the message on another one display module. As such, one of the users (such as patient) can express himself or herself to another one user (such as medical care personnel) through the system of the present invention. More preferably, the processing unit generates another one operator interface that is displayed on another screen of the other display module, and drives the screen of the other display module to display the message from the user (medical care personnel) on the screen of the display module that the other user (patient) uses.

It will be appreciated that although a particular embodiment of the invention has been shown and described, modifications may be made. It is intended in the claims to cover such modifications which come within the spirit and scope of the invention.

The invention claimed is:

1. An eye-controlled communication system, comprising:
an eye controlled aid, having a first display module, a first processing unit, an eye controlled module, the first processing unit electrically connected with the first display module and the eye controlled module, the eye controlled module detecting eye movements, generating a control command based on detected eye movements and transmitting the control command to the first processing unit; and
a visiting aid, having a second display module and a second processing unit, the second processing unit electrically connected with the second display module;
wherein the first processing unit bases on the control command transmitted from the eye controlled module to allow users to operate a first operator interface displayed on the first display module by using eye movements so that the first processing unit generates an execute command with an information according to operating results and transmits the execute command to the second processing unit; and wherein the second processing unit receives the execute command transmitted from the first processing unit and performs the execute command.

2. The eye-controlled communication system of claim 1, wherein the information of the execute command transmitted from the first processing unit includes text message, and the second processing unit drives the second display module to display the text message thereon after receiving the execute command transmitted from the first processing unit.

3. The eye-controlled communication system of claim 1, wherein the first processing unit is connected with the second processing unit by wireless communication or network communication.

4. The eye-controlled communication system of claim 1, wherein the second processing unit generates a second operator interface displayed on a second screen of the second display module that allows users to enter a message so that the second processing unit transmits the message to the first processing unit, and the first process unit receives the message and drives a first screen of the first display module to display the message thereon.

5. The eye-controlled communication system of claim 4, wherein the eye controlled aid further comprises a third display module electrically connected with the first processing unit; the first processing unit generating a third operator interface displayed on a third screen of the third display module to allow users to enter a message so that the first processing unit drives the first screen of the first display module to display the message from the third operator interface thereon.

6. The eye-controlled communication system of claim 4, wherein the eye controlled aid further comprises a main post; the first processing unit located inside of the main post; the first display module and the third display module are respectively connected with two sides of the main post.

7. The eye-controlled communication system of claim 6, wherein the eye controlled aid further comprises a first movable frame and a second movable frame; the first movable frame having two ends respectively connected with the first display module and one side of the main post; the second movable frame has two ends respectively connected with the third display module and another side of the main post; the first movable frame having several cantilevers, each of the cantilevers connected with each other and being capable of rotating relative to each other.

8. An eye-controlled communication system, comprising:
an eye controlled aid, having a first display module, a first processing unit, an eye controlled module and a third display module, the first processing unit electrically connected with the first display module, the third display module and the eye controlled module, the eye controlled module detecting eye movements, generating a control command based on detected eye movements and transmitting the control command to the first processing unit; and
a visiting aid, having a second display module and a second processing unit, the second processing unit electrically connected with the second display module;
wherein the first processing unit bases on the control command transmitted from the eye controlled module to allow users to operate a first operator interface displayed on the first display module by using eye movements so that the first processing unit generates an execute command with information according to operating results and transmits the execute command to the second processing unit; and wherein the second processing unit receives the information of the execute command transmitted from the first processing unit and displays the information on the second display module.

9. The eye-controlled communication system of claim 8, wherein the second processing unit generates a second operator interface displayed on a second screen of the second display module that allows users to enter a message so that the second processing unit transmits the message to the first processing unit, and the first process unit receives the message and drives a first screen of the first display module to display the message thereon.

10. The eye-controlled communication system of claim 8, wherein the first processing unit generates a third operator interface displayed on a third screen of the third display module to allow users to enter a message so that the first processing unit drives the first screen of the first display module to display the message transmitted from the third operator interface.

11. An eye-controlled communication system, comprising:
a main post;
a processing unit, located in the main post;
two display modules, respectively movably connected with the main post to adjust positions and angles of the two display modules, the two display modules electrically connected with the processing unit; and
an eye controlled module, located in one of the two display modules and electrically connected with the processing unit, the eye controlled module detecting eye movements, generating a control command based on detected eye movements and transmitting the control command to the processing unit;
wherein the processing unit generates an operator interface displayed on a screen of one of the two display modules, the processing unit bases on the control command transmitted from the eye controlled module to allow users to operate an operator interface displayed on one of the two display modules by using eye movements so that the processing unit generates an execute command with an information according to operating results and drives the other display module to display the information of the execute command on a screen of the display module.

12. The eye-controlled communication system of claim 11, wherein the processing unit generates another operator interface displayed on a screen of another one display module to allow users to enter a message so that the processing unit drives the screen of one of the two display modules to display the message thereon.
